(19) United States
(12) Patent Application Publication
(10) Pub. No.: US 2008/0307484 A1
(43) Pub. Date: Dec. 11, 2008

(54) SYSTEM AND METHOD OF ENABLING DIGITAL VIDEO BROADCAST ACCESS WITHIN AN INFORMATION HANDLING SYSTEM

(75) Inventors: Shree Dandekar, Round Rock, TX (US); Subramanian Jayaram, Austin, TX (US); James Clardy, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/759,024

(22) Filed: Jun. 6, 2007

(51) Int. Cl. H04N 5/445; H04N 7/16

(52) U.S. Cl. 725/133; 725/27; 725/38

(57) ABSTRACT

A system and method of enabling digital video broadcast access within an information handling system is disclosed. In one form, a method of enabling access to digital video broadcasts can include enabling use of a digital video broadcast (DVB) service access module within an information handling system. The method can also include determining an availability of a first DVB carrier using the DVB service access module and a DVB receiver module of the information handling system. The method can further include enabling access to the first DVB carrier, and receiving a first DVB signal including a first DVB channel data. The method can also include outputting the first DVB channel data using a media application of the information handling system.

### CROSS-REFERENCE TO RELATED APPLICATIONS

This application is related to U.S. patent application Ser. No. ______ entitled “System and Method of Accessing Multicast Digital Video Broadcasts” by Dandekar et al. filed on Jun. 6, 2007 (Attorney Docket No. DC-12937), and Ser. No. ______ entitled “System and Method of Accessing Digital Video Broadcasts within an Information Handling System” by Sicher et al. filed on Jun. 6, 2007 (Attorney Docket No. DC-13119) both of which are assigned to the current assignee hereof and are hereby incorporated by reference in their entireties.

### FIELD OF THE DISCLOSURE

This disclosure relates generally to information handling systems, and more particularly to a system and method of enabling digital video broadcast access within an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can be configured to use a variety of hardware and software components that can be configured to process, store, and communicate information and can include one or more computer systems, data storage systems, and networking systems.

Some network broadcast systems can configure digital video broadcast information to be communicated to target devices optimized to output specific digital video broadcast signals received from a specific carrier. For example, some portable electronic devices, such as wireless personal digital assistants (PDAs), mobile phones, cellular devices, or various other handheld devices, have limited resources to process and output received digital video broadcast signals. Handset manufacturers can employ carrier specific chipsets and applications within handsets to process and display digital video broadcasts on mini-displays or screens of portable electronic devices. However, limiting reception and display resolution of portable electronic devices and digital video broadcasts may not be desirable to various users.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 illustrates a functional block diagram of an information handling system incorporating a digital video broadcast access module according to one aspect of the disclosure;

FIG. 3 illustrates a flow diagram of a method of accessing digital video broadcasts using an information handling system according to one aspect of the disclosure; and

FIG. 4 illustrates a flow diagram of a method of enabling digital video broadcast service access in a build-to-order purchase order process according to one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a wireless communication device, a diskless computer system, a thin client, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

According to one aspect of the disclosure, an information handling system is disclosed. The information handling system can include a digital video broadcast (DVB) receiver module operable to receive DVB signals from a first DVB carrier. The information handling system can also include a DVB service access module configurable during fulfillment of a build-to-order manufacturing process. The information handling system can further include a processor operable to employ the DVB service access module to enable access to a first DVB service available by the first DVB carrier using the DVB receiver module.

According to another aspect of the disclosure, a method of enabling access to digital video broadcasts is disclosed. The method can include enabling use of a digital video broadcast (DVB) service access module within an information handling system. The method can also include determining an availability of a first DVB carrier using the DVB service access module and a DVB receiver module of the information handling system. The method can further include enabling access to the first DVB carrier, and receiving a first DVB signal including a first DVB channel data. The method can also include outputting the first DVB channel data using a media application of the information handling system.

According to a further aspect of the disclosure, a method of manufacturing an information handling system is disclosed. The method can include receiving a request to order a built-to-order information handling system, and determining a first DVB carrier accessible by the built-to-order information handling system. The method can further include generating a DVB service configuration during a manufacturing process of the built-to-order information handling system. In one form, the generating can include installing a reference to the first DVB carrier. The method can also include installing a DVB service access module and the DVB services configuration onto the built-to-order information handling system.

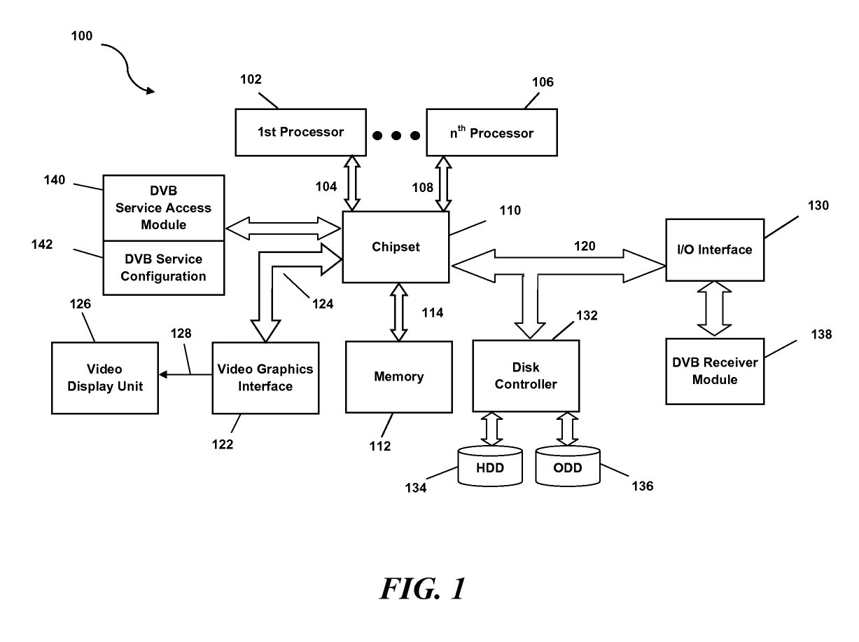

FIG. 1 illustrates a block diagram of an exemplary embodiment of an information handling system, generally designated at 100. In one form, the information handling system 100 can be a computer system such as a server. As shown in FIG. 1, the information handling system 100 can include a first physical processor 102 coupled to a first host bus 104 and can further include additional processors generally designated as n^{th} physical processor 106 coupled to a second host bus 108. The first physical processor 102 can be coupled to a chipset 110 via the first host bus 104. Further, the n^{th} physical processor 106 can be coupled to the chipset 110 via the second host bus 108. The chipset 110 can support multiple processors and can allow for simultaneous processing of multiple processors and support the exchange of information within information handling system 100 during multiple processing operations.

According to one aspect, the chipset 110 can be referred to as a memory hub or a memory controller. For example, the chipset 110 can include a dedicated bus to transfer data between first physical processor 102 and the n^{th} physical processor 106. For example, the chipset 110 including a chipset that can include a memory controller hub and an input/output (I/O) controller hub. As a memory controller hub, the chipset 110 can function to access the first physical processor 102 using first bus 104 and the n^{th} physical processor 106 using the second host bus 108. The chipset 110 can also be used as a memory interface for accessing memory 112 using a memory bus 114. In a particular embodiment, the buses 104, 108, and 114 can be individual buses or part of the same bus. The chipset 110 can also include bus control and can handle transfers between the buses 104, 108, and 114.

According to another aspect, the chipset 110 can include an application specific chipset that connects to various buses, and integrates other system functions. For example, the chipset 110 can include using an Intel® Hub Architecture (IHA) chipset that can also include two parts, a Graphics and AGP Memory Controller Hub (GMCH) and an I/O Controller Hub (ICH). For example, an Intel 820E, an 815E chipset, an Intel 975X chipset, an Intel G965 chipset, available from the Intel Corporation of Santa Clara, Calif., or any combination thereof, can be used as at least a portion of the chipset 110. The chipset 110 can also be packaged as an application specific integrated circuit (ASIC).

In one form, the chipset 110 can be coupled to a video graphics interface 122 using a third bus 124. In one form, the video graphics interface 122 can be a Peripheral Component Interconnect (PCI) Express interface operable to content to display within a video display unit 126. Other graphics interfaces may also be used. The video graphics interface 122 can output a video display output 128 to the video display unit 126. The video display unit 126 can include one or more types of video displays such as a flat panel display (FPD), cathode ray tube display (CRT) or other type of display device.

The information handling system 100 can also include an I/O interface 130 that can be connected via an I/O bus 120 to the chipset 110. The I/O interface 130 and I/O bus 120 can include industry standard buses or proprietary buses and respective interfaces or controllers. For example, the I/O bus 120 can also include a PCI bus or a high speed PCI-Express bus. In one embodiment, a PCI bus can be operated at approximately 66 MHz and a PCI-Express bus can be operated at more than one (1) speed (e.g. 2.5 GHz and 5 GHz). PCI buses and PCI-Express buses can comply with industry standards for connecting and communicating between various PCI-enabled hardware devices. Other buses can also be used in association with, or independent of, the I/O bus 120 including, but not limited to, industry standard buses or proprietary buses, such as Industry Standard Architecture (ISA), Small Computer Serial Interface (SCSI), Inter-Integrated Circuit (I²C), System Packet Interface (SPI), or Universal Serial buses (USBs).

In an alternate embodiment, the chipset 110 can be a chipset employing a Northbridge/Southbridge chipset configuration (not illustrated). For example, a Northbridge portion of the chipset 110 can communicate with the first physical processor 102 and can control interaction with the memory 112, the I/O bus 120 that can be operable as a PCI bus, and activities for the video graphics interface 122. The Northbridge portion can also communicate with the first physical processor 102 using first bus 104 and the second bus 108 coupled to the n^{th} physical processor 106. The chipset 110 can also include a Southbridge portion (not illustrated) of the chipset 110 and can handle I/O functions of the chipset 110. The Southbridge portion can manage the basic forms of I/O such as Universal Serial Bus (USB), serial I/O, audio outputs, Integrated Drive Electronics (IDE), and ISA I/O for the information handling system 100.

The information handling system 100 can further include a disk controller 132 coupled to the I/O bus 120, and connecting one or more internal disk drives such as a hard disk drive (HDD) 134 and an optical disk drive (ODD) 136 such as a Read/Write Compact Disk (R/W CD), a Read/Write Digital Video Disk (R/W DVD), a Read/Write mini-Digital Video Disk (R/W mini-DVD), or other type of optical disk drive.

In one form, the information handling system 100 can include a DVB receiver module 138 coupled to an the I/O interface 130 and operable to be used with a DVB service access module 140 of the IHS 100 to access DVB services of one or more DVB carrier. In one form, a DVB broadcast can include a DVB-H broadcast signal configured to be received by a handheld device operable to receive and output digital video broadcasts using a mobile handheld device including reduced-sized or mini-displays to display video and textual data. DVB-H broadcasts can be transmitted by wireless DVB carriers using a time-slicing technique that can allow the DVB receiver module 138 to receive DVB channel data in short intervals, and can turn off or disable a portion of the DVB receiver module 138 during inactive periods. As such, a reduction in battery life of the information handling system 100 can be realized.

According to one aspect, DVB -H broadcasts can also allow reception of video broadcast signals for various broadcast stations, programming, etc. DVB-H broadcasts are standardized broadcasts that comply with DVB-H specifications. DVB-H broadcasts can also allow reception of video broadcast signals for various broadcast stations, programming, etc. DVB-H broadcasts can be standardized broadcasts that comply with DVB-H specification DVB-H, published as European Telecommunication Standards Institute (ETSI) Standard EN 302 304 v1.1.1 in November 2004. Other types of broadcasts can also be used as desired, including, but not limited to, Integrated Services Digital Broadcast—Terrestrial (ISDB-T) in Japan, Terrestrial-Digital Multimedia Broadcasting (T-DMB) in Korea and DAB, incl. Digital Audio Broadcasting—Internet Protocol (DAB-IP) and Enhanced Packet mode Digital Audio Broadcasting (DAB) in Europe Middle East Asia (EMEA).

In one form, the DVB receiver 138 can be a removable card or expansion card that can be coupled to the I/O interface 130 as an add-on, or optional accessory or device of the information handling system 100. The DVB receiver module 138 can be coupled to the I/O interface 130 and can receive power from the information handling system 100 via the I/O interface 130. The DVB receiver module 138 can further include a DVB receiver module driver, software, or logic that can be employed by the information handling system 100 and the DVB receiver module 138 to access and use of the DVB receiver module 138 using one or more applications of the IHS 100.

During use, the DVB receiver module 138 can periodically receive DVB-H broadcast signals from a DVB carrier and convert or decode the DVB broadcast signals to DVB broadcast data that can be formatted and communicated via the I/O interface 130. In one form, the DVB broadcast or channel data can be formatted into a communication bus dependent format. For example, the I/O interface 130 can include a PCI Express communication bus and the DVB-H broadcast data can be formatted into a signal that can be communicated via the PCI Express communication bus of the information handling system 100. Other types of buses can also be employed as desired.

The DVB service access module 140 can access a DVB service configuration 142 to determine one or more service and carrier broadcasting a DVB signal and accessible using the DVB receiver module 138. The DVB service configuration 142 can be stored within a memory of the information handling system 100 and can include service configuration references or information that can be access by the DVB service access module 140. The DVB service access module 140 can be functionally linked to the DVB receiver module 138 and initiate access to one or more DVB carrier included within the DVB service configuration. Although illustrated as separate components or modules, the DVB service configuration 142, the DVB service access module 140, the DVB receiver module 138, or any combination thereof, can be combined into a single component, card, module, logic, or any other type of hardware, firmware, or software.

Upon determining a DVB carrier using the DVB service configuration 142, the DVB receiver module 138 can receive a DVB signal communicated by a DVB carrier. The DVB signal can include formatted data that can be processed and decoded to output using the video display output 126. The DVB signal received by the DVB receiver 138 can include multiple channel data that may or may not be subscribed to by a user of the information handling system 100. For example, a first DVB service can include access a first set of DVB channels and a reference to the subscribed service can be stored within the DVB service configuration and accessed by the DVB service access module 140. The DVB service access module 140 can communicate a signal to the DVB receiver module 138 to enable or disable access to DVB channels received by the DVB receiver module 138. As such, the DVB receiver module 138 can communicate channel data subscribed to by the information handling system 100 thereby reducing DVB channel data communicated via the I/O interface 130 of the information handling system 100.

However, in another embodiment, the DVB receiver module 138 can communicate each channel received within the DVB signal, and the DVB service access module 140 can limit access to one or more channels on a subscription basis. In this manner, DVB-H broadcast signals can be received by a DVB receiver module 138 coupled to the information handling system 100 via an I/O interface and resources of the information handling system 100 can be used to output the DVB-H signal data thereby enabling access of DVB-H broadcast data and services of a specific DVB carrier. Additionally, a reduced amount of resources may be realized within the DVB receiver module 138 to enable access to DVB services thereby allowing for a simplification of processing at the DVB receiver module 138 in some forms.

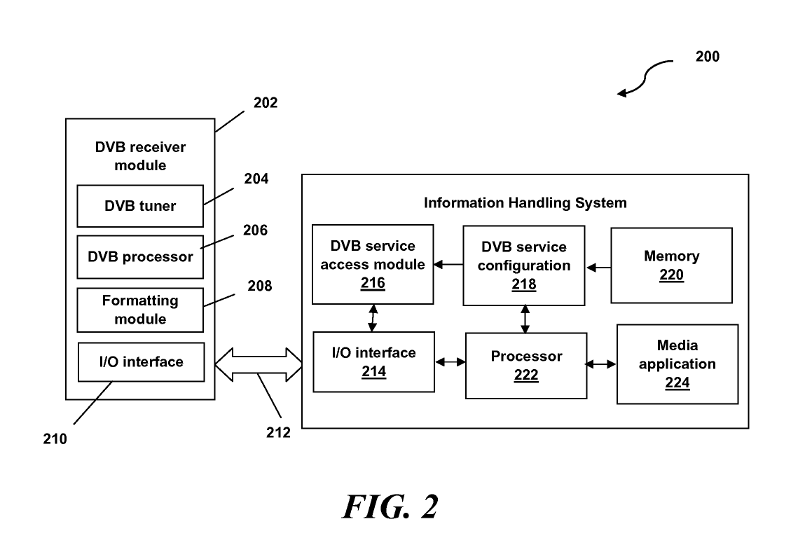

FIG. 2 illustrates a functional block diagram of an information handling system, illustrated at 200, configured to access digital video broadcast services according to one aspect of the disclosure. The information handling system (IHS) 200 can include a DVB receiver module 202 including a DVB tuner 204, a DVB processor 206, a formatting module 208, and an I/O interface 210. The I/O interface 210 can be coupled to an I/O interconnect bus 212 and a second I/O interface 214. The IHS 200 can further include a DVB service access module 216, a DVB service configuration 218, a memory 220, a processor 222, and a media application 224. The IHS 200 can also include additional components, resources, or any combination thereof, and can be configured similar to the information handling system 100 illustrated in FIG. 1, or various other information handling systems as desired.

During use, the IHS 200 can enable and disable access to DVB services using the DVB service configuration 218 and DVB service access module 216. The DVB service access module 216 can include logic that can be executed by the processor 222, or in other forms, can be configured as a separate hardware component including encoded logic that can enable access to DVB services and DVB channel data. According to one aspect, the DVB service access module 216 can be operably coupled to the DVB receiver module 202 and can enable access to DVB signals and DVB channel data of a specific DVB carrier on limited basis. For example, the DVB access module 216 can access a DVB service configuration 218 of the IHS 200 and can enable access to one or more services of a specific DVB carrier. As such, the DVB receiver module 202 can process the received DVB signal using the DVB processor 206 to access specific DVB channel data. The DVB receiver module 202 can format the specific DVB channel data and communicate the formatted DVB channel data via the I/O interface 210 to the second I/O interface 214 via the interconnect bus 212. The processor 222 can couple the formatted DVB channel data to the media application 224 to output.

According to a further aspect, the DVB service access module 216 and the DVB service configuration 218 can be employed to enable and disable access to multiple DVB carriers. For example, the IHS 200 can be configured to access multiple DVB services that can be subscribed to by a user of the IHS 200 and accessed as desired. The DVB receiver module 202 can be configured to receive signals from more than one DVB carrier using the DVB tuner 204. However in other forms, more than one DVB tuner 204, DVB receiver module 202, or any combination thereof, can be used to access multiple DVB carrier signals. The DVB access module 216 can initiate access to the multiple DVB carrier signals as a user elects to access a specific service. As such, a user of the IHS 200 need not access multiple software applications, user interfaces, or network dependent hardware to obtain DVB channel data from multiple DVB carriers. Additionally, as availability of one DVB carrier is limited, a second DVB carrier can be accessed by the IHS 200 to output a DVB broadcast data to a user of the IHS 200.

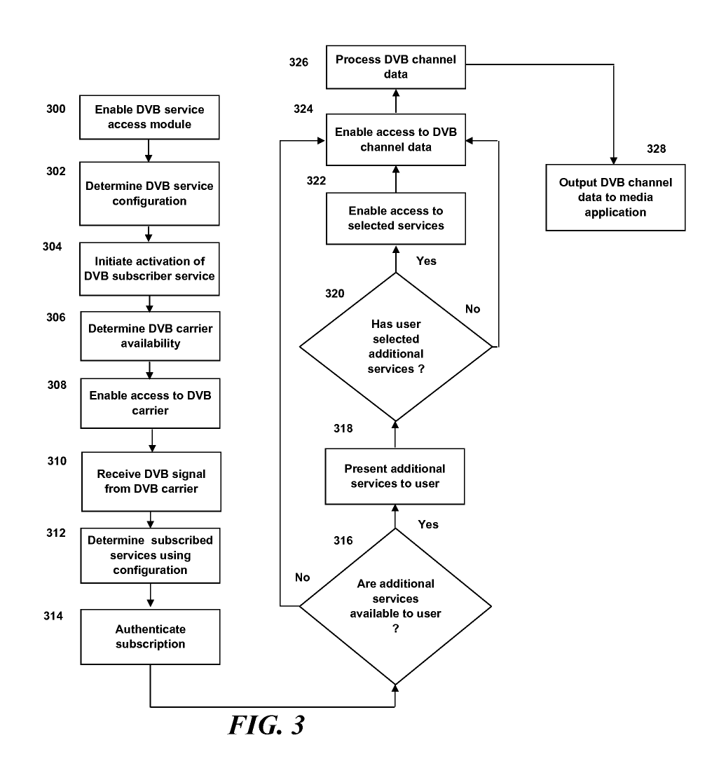

FIG. 3 illustrates a flow diagram of a method of accessing digital video broadcasts using an information handling system according to one aspect of the disclosure. FIG. 3 can be employed in whole, or in part, by the information handling system 100 depicted in FIG. 1, the DVB processing system 200 described in FIG. 2, or any other type of system, controller, device, module, processor, or any combination thereof, operable to employ all, or portions of, the method of FIG. 3. Additionally, the method can be embodied, in whole or in part, in various types of encoded logic including software, firmware, hardware, or other forms of digital storage mediums, computer readable mediums, logic, or any combination thereof, operable to provide all, or any portions of, the method of FIG. 3.

The method begins generally at block 300 as a DVB service access module is enabled. For example, a DVB service access module can be enabled in association with an IHS initializing, booting or rebooting, powering-up, etc. In other forms, the method can be initialized based a user interacting with an IHS that may already be initialized as a user selects a software application or program that can initiate enabling a DVB service access module. At block 302, the method determines a DVB service configuration of the IHS. For example, a DVB service configuration can be stored within a memory of an IHS and can include one or more references to DVB related subscription services. In one form, DVB services can include access a specific DVB carrier having one or more broadcast channels that can be subscribed to by a user and a reference stored within a DVB service configuration. In another form, multiple DVB carrier references can be stored in association with the DVB service configuration and can be employed to access multiple DVB carriers. In another embodiment, a reference to a data service can be stored in association with the DVB service configuration to enable access to data services of the DVB carrier. In yet another form, a reference to a pay-per-view service can be stored in association with the DVB service configuration to enable access specific programming of the DVB carrier on a pay-per-view basis. Other service references can also be stored as DVB services and service providers expand available services to DVB enabled devices and systems.

Upon determining a DVB service configuration, the method can proceed to block 304 initiates activation of a DVB subscriber service. For example, an IHS can be configured to access one or more DVB services provided by a DVB carrier or provider. For example, a DVB subscriber service can include accessing a wireless data carrier, such as a cellular or mobile transmission carrier, that can communicate alone or in combination, data signals, voice signals, DVB broadcast signals, or other forms of wireless media signals. In one form, the IHS can include accessing wireless, terrestrial service providers, or any combination thereof, including, but not limited to, DVB services provided by Hutchison Whampoa's Group 3 Italia, Vodafone, T-Systems/T-Mobile, Canal Plus, or various other carriers or services providers.

The method can proceed to block 306, and determines if a DVB carrier availability. For example, the IHS can scan available carriers or broadcasts using a wireless communication device or DVB receiver module of the IHS. Upon determining a specific carrier is available, the method can proceed to block 308 and enables access the DVB carrier. For example, a subscription identifier, password, key, or other form of authentication, can be used to enable access to the DVB carrier. Upon enabling access, the method can proceed to block 310 and the DVB receiver module of the IHS can receive a DVB signal including at least one DVB channel data. The method can then proceed to block 312 and determines subscribed services of the IHS using the DVB services configuration, and proceeds to block 314 and authenticates the subscription to the services. For example, the DVB signal can include DVB channel data of multiple DVD channels and, using the subscription services configuration, access to a first set of DVB channels can be enabled while access to a second set of DVB channels not subscribed to can be restricted or disabled.

Upon authenticating subscription services, the method can proceed to block 316 and if additional services are available, the method can proceed to block 318 and present additional services to a user within a selectable user interface of the IHS. For example, additional services can include DVB channels that may be available to a user but not subscribed to. As such, a selectable reference to services can be displayed to a user to allow a user to select such services. For example, the DVB service provider can include promoting services to a user. As such, the DVB carrier can download a listing of additional services that can be accessed and presented to the user to select one or more additional services. In one form, the additional services can be enabled using a “pay-per-view” model that can be linked to a subscriber account of a user. As such, a user can be billed for the additional services. Additionally, specific program channels, or access to one or more packaged channels (e.g. sporting events, tournaments, playoffs, etc.), can be selected. For example, services can also include video-on-demand, music services or downloads, adult only content, secure private data services, or various other combinations. In one form, a service provider can reserve a specific amount of bandwidth to allow for communicating specific data to an end user.

If additional services are not available, or a user does not select additional services, the method can proceed to block 324 as described above. If at block 320, a user selects one or more additional services, the method can proceed to block 322 and access to additional services can be enabled. For example, access can include updating a DVB service configuration of the IHS, updating a DVB service access module, storing a service reference within a memory of the IHS, sending a subscription authenticating signal to a carrier, or any combination thereof. Other forms of service enablement can also be employed.

The method can then proceed to block 324, and access to DVB channel data can be enabled. The method can then proceed to block 326 and, the DVB channel data can be processed and output to a media application at block 328. For example, the DVB channel data can be processed using one or more resources of the IHS and can be formatted to be output to a specific media application. In one form, the DVB channel data can include a DVB-H broadcast format that can be processed or translated to a format that can be output using a media application, such as Windows Media Player by Microsoft Corporation, Cyberlink's H.264 player, or various other H.264 players. In one form, the IHS using a DVB receiver can receive DVB channel data via a DVB signal and at block 326, the DVB data can be processed by the IHS. For example, the DVB data can be decompressed, decapsulated, enhanced, modified, etc. to be output by an IHS. Upon processing the DVB data, the DVB data can be output using a media application of the IHS. In another form, the DVB channel data can be processed to extract various types of additional content such as advertisements, electronic services guide data, channel logos or identifiers, or various other types of data. According to another aspect, the DVB channel data may not be formatted to be compatible with output capabilities of the IHS. As such, the IHS can process to alter or enhance the DVB channel data prior to outputting to a media application of the IHS. Upon outputting the DVB channel data, the method can proceed to output the DVB channel data as desired.

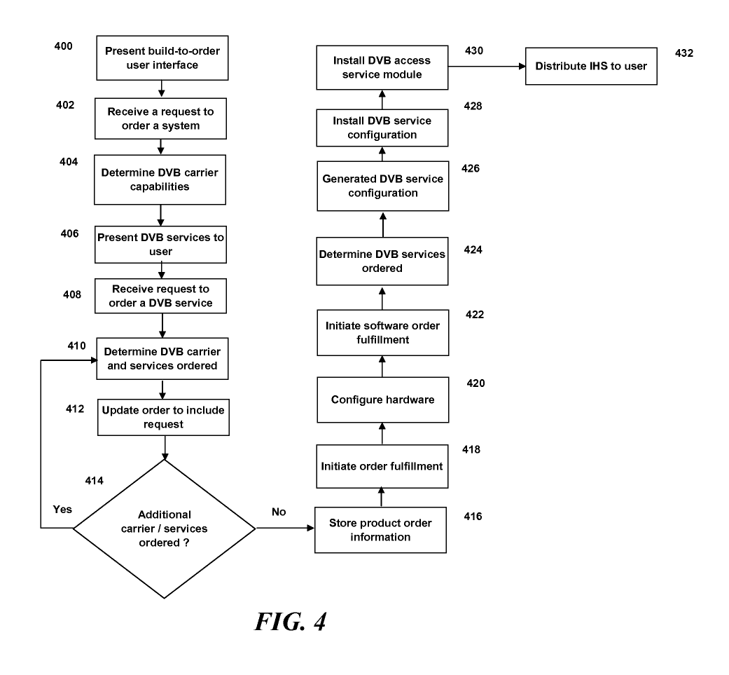

FIG. 4 illustrates a flow diagram of a method of enabling digital video broadcast service access in a build-to-order purchase order process according to one aspect of the disclosure. FIG. 4 can be employed in whole, or in part, by the information handling system 100 depicted in FIG. 1, the DVB processing system 200 described in FIG. 2, or any other type of system, controller, device, module, processor, or any combination thereof, operable to employ all, or portions of, the method of FIG. 4. Additionally, the method can be embodied, in whole or in part, in various types of encoded logic including software, firmware, hardware, or other forms of digital storage mediums, computer readable mediums, logic, or any combination thereof, operable to provide all, or any portions of, the method of FIG. 4.

The method begins generally at block 400 as a user accesses a resource to order a build-to-order information handling system such as portable computer system, desktop computer system, server, or any other type of IHS that can be accessed using a build-to-order interface. The build-to-order information can be presented to a user, and at block 402, a purchase order to order a build-to-order system can be received by a manufacturer. The method can then proceed to block 404, and can determine if the selected build-to-order system can be enabled to receive a DVB broadcast from a DVB carrier. If the build-to-order system is capable, the method can proceed to block 408 and can present DVB services that can be ordered. The method can then proceed to block 408, and receives a request to order a DVB service in association with the build-to-order system. The method can then proceed to block 410 and determines DVB services and one or more associated DVB carriers that can provide the selected services. The method can proceed to block 412 and a build-to-order order request can be updated to include the additional DVB services ordered by a user. The method can then proceed to block 414 and if additional services are ordered, proceed to block 410 as described above.

If at block 414, no additional services are ordered, the method can proceed to block 416 and order information including any ordered DVB services can be stored. The method can then proceed to block 418 and initiates fulfilling the requested order. For example, the order can be sent to a manufacturing facility that can produce a built-to-order IHS. At block 420, the hardware of the requested IHS can be configured. For example, if a user ordered a specific type of DVB service, the build-to-order system can be configured to include a specific type of DVB receiver module that can receive DVB signals from one or more DVB carrier.

Upon configuring the hardware, the method can proceed to block 422 and application software, one or more operating system, and various other applications can be installed on the IHS. The method can then proceed to block 424 and determines if one or more DVB services have been ordered. For example, a user may select one or more type of DVB service to be accessible by the user upon the user receiving or taking delivery of the IHS. As such, at block 426, a DVB service configuration can be generated to be used by the IHS. For example, a DVB service configuration can include logic, authentication keys, passwords, encryption keys, etc. that can be stored within a memory of the IHS. Upon configuring a DVB service configuration, the DVB service configuration can installed onto the IHS at block 428. The method can then proceed to block 430, and a DVB access service module can be installed onto the IHS. For example, the DVB access service module and the DVB service configuration can be stored with a memory device of the IHS, or in other forms, can be stored within a storage device, such as a hard drive, flash drive, flash memory, or other type of memory that can be employed by an IHS. The method can then proceed to block 432 and the IHS can be distributed to the end user. In this manner, a user can select DVB services when a build-to-order system is ordered allowing a user to access DVB broadcasts and services without having to download additional software, access keys, passwords, etc. to access DVB broadcasts.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a digital video broadcast (DVB) receiver module operable to receive DVB signals from a first DVB carrier;
a DVB service access module configurable during fulfillment of a build-to-order manufacturing process; and
a processor operable to employ the DVB service access module to enable access to a first DVB service available by the first DVB carrier using the DVB receiver module.

2. The information handling system of claim 1, further comprising a DVB service configuration accessible by the DVB service access module, the DVB service configuration including a first DVB carrier identifier and a first DVB service identifier.

3. The information handling system of claim 2, wherein the DVB service configuration further comprises:
a second DVB carrier identifier operable to identify a second DVB carrier accessible by the DVB receiver module; and
a second DVB service identifier operable to identify a second DVB service of the second DVB carrier.

4. The information handling system of claim 3, further comprising a first reference to a first set of DVB services subscribed to in association with a built-to-order order process.

5. The information handling system of claim 4, wherein:
the DVB service access module is further operable to receive an availability reference to an available DVB service; and
the processor is further operable to output to a user a selectable reference to the availability reference.

6. The information handling system of claim 5, wherein:
the processor is further operable to initiate an updating of the DVB service configuration to enable access to additional service upon selection of the selectable reference;
the DVB service access module is further operable to enable access to the additional DVB service; and
the DVB receiver module is further operable to receive data responsive to the enabling access to the additional DVB service.

7. The information handling system of claim 1, further comprising:
a memory device configured to store a plurality of authentication references to a plurality of DVB carriers;
wherein the DVB receiver module is further operable to determine an availability of at least one of the plurality of DVB carriers; and
wherein the DVB receiver module is further operable to initiate access to at least one of the plurality of DVB carriers using at least one of the authentication references.

8. The information handling system of claim 1, wherein the DVB receiver module further is operable to establish a network uplink to a data service of the first DVB carrier.

9. A method of enabling access to digital video broadcasts comprising:
enabling use of a digital video broadcast (DVB) service access module within an information handling system;
determining an availability of a first DVB carrier using the DVB service access module and a DVB receiver module of the information handling system;
enabling access to the first DVB carrier;
receiving a first DVB signal including a first DVB channel data; and
outputting the first DVB channel data using a media application of the information handling system.

10. The method of claim 9, further comprising:
determining an availability of a first DVB service of the first DVB carrier;
authenticating a subscription to the first DVB service; and
enabling access to the first DVB service.

11. The method of claim 9, further comprising:
accessing a DVB service configuration of the information handling system;
receiving the first DVB signal from the first DVB carrier; and
enabling access to the first DVB channel data in response to accessing the DVB service configuration.

12. The method of claim 11, further comprising:
accessing a plurality of DVB channel data within the first DVB signal;
determining an availability of a subscription to a first set of DVB channels;
enabling access to the first set of DVB channels and associated DVB channel data in response to determining the subscription; and
disabling access to a second set of DVB channels, the second set of DVB channels being different from the first set of DVB channels.

13. The method of claim 12, further comprising:
determining an availability of a first additional DVB service accessible using the DVB receiver module and not subscribed to by the information handling system;
presenting a reference to the availability of the first additional DVB service;
receiving a request from a user to access the first additional DVB service; and
enabling accessing to the first additional DVB service.

14. The method of claim 11, further comprising:
receiving an available DVB service reference within the first DVB signal;
determining the DVB service configuration does not include access to an available DVB service of the available DVB service reference;
presenting an indication of the available DVB service to a user;
receiving a request to access the available DVB service from the user; and
enabling access to the available DVB service.

15. The method of claim 14, further comprising:
accessing the DVB service configuration; and
updating the DVB service configuration to include access to the available DVB service.

16. The method of claim 9, further comprising:
accessing the DVB service access module configured during a build-to-order manufacturing process of the information handling system;
receiving a request to update the DVB service access module; and
updating the DVB service access module.

17. A method of manufacturing an information handling system, the method comprising:
receiving a request to order a built-to-order information handling system;
determining an availability of a first DVB carrier accessible by the built-to-order information handling system;
generating a DVB service configuration during a manufacturing process of the built-to-order information handling system, the generating including installing a reference to the first DVB carrier; and
installing a DVB service access module onto the built-to-order information handling system; and
installing the DVB services configuration onto the built-to-order information handling system.

18. The method of claim 17, further comprising:
presenting a first DVB service to a user during an build-to-order ordering process;
receiving a request to order the first DVB service from a user during the build-to-order ordering process;
updating an order to include the request to order the first DVB service; and
installing a first DVB service identifier operable to identify the ordered first DVB service.

19. The method of claim 17, further comprising:
receiving a request to order the build-to-order information handling system;
determining an availability of at least one DVB service that can be accessed by the build-to-order information handling system; and
presenting a selectable reference to the at least one DVB service to a user prior processing the order.

20. The method of claim 17, further comprising:
determining an availability of a second DVB carrier accessible by the built-to-order information handling system;
generating the DVB service configuration to include a second reference to the second DVB carrier; and
enabling the DVB service access module to initiate access to the first DVB carrier and the second DVB carrier.
